(19) United States
(12) Patent Application Publication
(10) Pub. No.: US 2017/0136487 A1
(43) Pub. Date: May 18, 2017

(54) DISPENSING AND METERING DEVICE FOR LIQUIDS AND OILS

(71) Applicant: National Concessions Group Inc., Denver, CO (US)

(72) Inventors: Andrew Rexroad, Denver, CO (US); Chris McElvany, Denver, CO (US); Mike Eckles, Golden, CO (US); Jim Paradise, Lakewood, CO (US)

(21) Appl. No.: 15/353,496

(22) Filed: Nov. 16, 2016

Related U.S. Application Data
(60) Provisional application No. 62/255,927, filed on Nov. 16, 2015.

(51) Int. Cl. B05C 17/005; B05C 17/01

(52) U.S. Cl. CPC B05C 17/00503; B05C 17/0116

(57) ABSTRACT

A dispensing device for storing and dispensing oils and other viscous liquids is provided. The device comprises an elongate body member and a dispensing tip. The dispensing tip comprises a valve member that is biased toward a closed position to prevent unwanted egress of device contents. In order to dispense device contents, a force is applied to the contents within the device, and that force is transmitted to the valve member to urge the valve member toward a temporary open position and allow contents to be dispensed.

This U.S. Non-Provisional Patent Application claims the benefit of priority from U.S. Patent Application Ser. No. 62/255,927, filed Nov. 16, 2015, the entire disclosure of which is hereby incorporated by reference.

### FIELD

The present disclosure generally relates to systems and devices for storing and dispensing liquids and oils. More specifically, the present disclosure provides unique portable and handheld systems for storing a predetermined amount of liquid or oil and having features for selective metering and dispensing of the liquid or oil. Systems of the present disclosure are adapted for, among other things, dispensing oils and providing oil to vaporizer devices, reels, fine instruments, guns, bicycle components, leather goods, tools, and various other devices requiring or benefiting from the application of oils.

### BACKGROUND

Known devices for dispensing products, such as extracted oils to be vaporized, include devices similar to or the same as those used in the medical industry. Such devices are subject to numerous drawbacks and shortcomings and include, for example, syringes for dosing liquid drugs to a patient, such as antibiotics. In addition to the unsettling appearance, known syringes fail to provide a device that consistently and accurately dispenses a desired or predetermined amount of its contents. Such devices also generally comprise an open-ended device prone to leakage.

### SUMMARY

Accordingly, there has been a long-felt and unmet need to provide a dispensing device for oils and liquids with the ability to temporarily store oils and liquids, dispense preferred amounts of the oils and liquids with a degree of accuracy, and provide an enhanced level of user-friendliness.

It is an object of the present disclosure to provide a dispensing device with a dispensing end adapted to accurately dispense and transfer oils or liquids stored within the device. It is yet another object of embodiments of the present disclosure to provide a device that is capable of repeatedly dispensing a consistent and/or discrete amount of contents from the device based upon a single repeatable action from a user, such as the depression of a button provided on the device. It is another object of embodiments of the present disclosure to provide a dispensing feature such as an incremental plunger, wherein a mechanical follower is provided such that with each pre-measured dose that is dispensed the device is primed or generally ready to dispense a next pre-measured dose until the oil storage is depleted.

In certain embodiments, a dispensing device is provided with a first end and a second end, the second end comprising an outlet and wherein the outlet comprises a biased valve member. In certain embodiments, the biased valve member comprises a ball bearing that is capable of being displaced to allow for dispensing of device contents stored within the device. The ball bearing is preferably biased toward a closed position such that leakage and inadvertent dispensing of contents is substantially prevented. Upon depression of an activation feature, such as a button, plunger, or other activating feature, a compressive force is applied to the contents of the device, and some or all the compressive force is transferred from the contents to the ball bearing and biasing element (e.g. in one embodiment, a coil spring) to force open the valve member and allow for egress of contents from the device.

In one embodiment, a dispensing device is provided for dispensing fluids, such as oils and viscous liquids, the device comprising an elongate body member comprising a first end and a second end. The first end comprises a contact point for a user, and the second end comprises a dispensing tip. The device comprises an interior volume for storing a predetermined amount of a fluid, and the interior volume is provided within the elongate body member and at least partially disposed between the contact point and the dispensing tip. The contact point is interconnected to a follower or plunger for applying a compression force to the predetermined amount of fluid provided within the interior volume. The dispensing tip comprises a valve member and a biasing member, the biasing member being provided in force-transmitting communication with the valve member and biasing the valve member toward a closed position. Upon activation of the device, the follower provides a compression force to the predetermined amount of fluid and the forces the valve member to an open position to allow for a second predetermined amount of fluid to be dispensed from the dispensing tip. In alternative embodiments, it is contemplated that the device does not comprise an elongate structure, and may take on various forms including spherical, rectangular or cubical, or stout members. Accordingly, various features and inventions disclosed herein may be provided in various objects and although certain embodiments contemplate an elongate structure, the present disclosure will not be viewed as being limited to such structures.

In one embodiment, a dispensing device for dispensing fluids, such as oils and viscous liquids, is provided, the device comprising an elongate body member comprising a first end and a second end. The first end comprises a contact point for a user, and the second end comprises a dispensing tip. An interior volume is provided for storing a predetermined amount of fluid, and the interior volume is provided within the elongate body member and at least partially disposed between the contact point and the dispensing tip. The contact point is interconnected to a plunger, the plunger comprising a surface for applying a compression force to the fluid stored within the reservoir or interior volume.

The dispensing tip comprises a valve member and a biasing member, the biasing member being provided in force-transmitting communication with the valve member and biasing the valve member toward a closed position. Upon activation of the contact point, the plunger provides a compression force to the volume of fluid within the device and the forces the valve member to an open position to allow for a second predetermined amount of fluid to be dispensed from the dispensing tip. In preferred embodiments, a movement of the plunger will create an increase in a pressure in the contents of the device. This pressure or force is transmitted toward a distal or dispensing end of the device and operates to force open a biased valve member in or proximal to the dispensing tip. When the valve member is opened, a finite amount of device contents will exit the storage area. The movement or egress of these contents reduces the pressure to a point where the biasing member of the valve returns the valve to closed position and prevents further dispensation of device contents, at least until a user selectively dispenses additional contents.

In one embodiment, a dispensing device for dispensing fluids, such as oils and viscous liquids, is provided, the device comprising a body member comprising a first end and a second end. The first end comprises a user interface, and the second end comprises a dispensing tip. An interior volume for storing a first predetermined amount of oil is provided, the interior volume at least partially disposed between the user interface and the dispensing tip. The user interface is in communication with a plunger, the plunger comprising a surface for applying a compression force to the of oil. The dispensing tip comprises a valve member, the valve member comprising a biasing member in force-transmitting communication with the dispensing tip and a ball bearing, the biasing member biasing the ball bearing toward a closed position. Upon activation of the user-interface, the plunger provides a compression force to the oil and the forces the ball bearing to an open position to allow for a second predetermined amount of fluid to be dispensed from the dispensing tip. The force applied by the biasing member is selected at a predetermined level such that when the pressure of the compressed fluid is reduced to a level less than that of the biasing member, the biasing member repositions the ball bearing to a closed position halting the egress of fluid from the device. Knowing the size of the liquid storage chamber, the cross-sectional area of the dispensing opening and an opening of the valve member, the pressure applied by the plunger and the force of the biasing member may be selected to achieve release of a predetermined volume of oil consistently for each activator.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

### BRIEF DESCRIPTION OF THE DRAWINGS

The accompanying drawings, which are incorporated in and constitute a part of the specification, illustrate embodiments of the disclosed system and together with the general description of the disclosure given above and the detailed description of the drawings given below, serve to explain the principles of the disclosure.

FIG. 1 is a front elevation view of a dispensing device according to one embodiment of the present disclosure.

FIG. 2A is a top perspective view of a component of a dispensing device according to one embodiment of the present disclosure.

FIG. 2B is a bottom perspective view of a component of a dispensing device according to one embodiment of the present disclosure.

FIG. 2C is a front elevation view of a component of a dispensing device according to one embodiment of the present disclosure.

FIG. 2D is a front elevation view of a component of a dispensing device according to one embodiment of the present disclosure, with certain features shown in phantom for illustrative purposes.

FIG. 3 is a cross-sectional elevation view of a component of a dispensing device according to an embodiment of the present disclosure.

FIG. 4A is a top plan view of a component of a dispensing device according to one embodiment of the present disclosure.

FIG. 4B is a dimensioned elevation view of a component of a dispensing device according to the embodiment of FIG. 4A.

FIG. 4C is a dimensioned elevation view of a component of a dispensing device according to the embodiment of FIG. 4A.

FIG. 4D is a top perspective view of a component of a dispensing device according to the embodiment of FIG. 4A.

FIG. 4E is a bottom perspective view of a component of a dispensing device according to the embodiment of FIG. 4A.

FIG. 5A is a top perspective view of a component of a dispensing device according to one embodiment of the present disclosure.

FIG. 5B is a top plan view of a component of a dispensing device according to the embodiment of FIG. 5A.

FIG. 6 is an exploded view of a dispensing device according to one embodiment of the present disclosure.

FIG. 7 is a cross-sectional elevation view of a dispensing device according to one embodiment of the present disclosure.

FIG. 8A is a top perspective view of a plunger member according to one embodiment of the present disclosure.

FIG. 8B is a front elevation view of a plunger member according to one embodiment of the present disclosure.

FIG. 8C is a cross-sectional elevation view of a plunger member according to one embodiment of the present disclosure.

FIG. 9 is a side view of a feature of a dispensing device of FIG. 6.

FIG. 10 is a side view of components of the dispensing device of FIG. 6.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular system embodiments illustrated herein.

### DETAILED DESCRIPTION

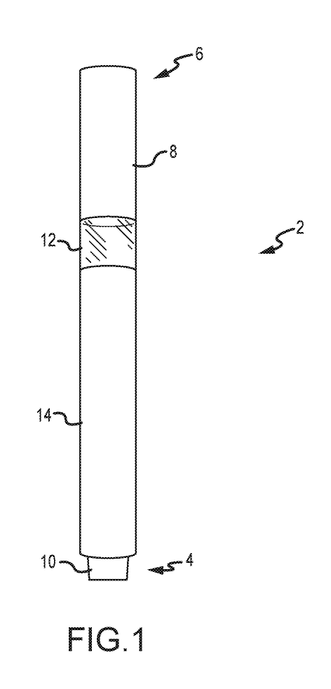

FIG. 1 is a front elevation view of an oil dispensing device 2 comprising an elongate body portion, a proximal end 4 and a distal end 6. The distal end 6 is provided with a removable cap 8 in the depicted embodiment. The elongate body portion of the device 2 comprises a visual indicium 12 to display information related to at least one of a type and quantity of contents provided within the device. In the depicted embodiment, the visual indicium 12 comprises a translucent or transparent portion of the boy portion through which a storage volume for contents is visible. Alternatively, the visual indicium may be a gauge or fill-level needle providing information as to the quantity of fluid within the storage volume. It is also contemplated that a plunger 56 of the present disclosure comprises a high-visibility coating or color, such that is easily recognized through the indicium, even in the presence of fluid or other contamination. A remainder of the elongate body portion 14 comprises internal working components for dispensing device contents out through the distal end 6 as shown and described herein. A user-interface 10, which is shown in the form of a button in FIG. 1 is provided on a proximal end 4 of the device 2. A distal end 6 of the device is provided with a selectively removable cap 8.

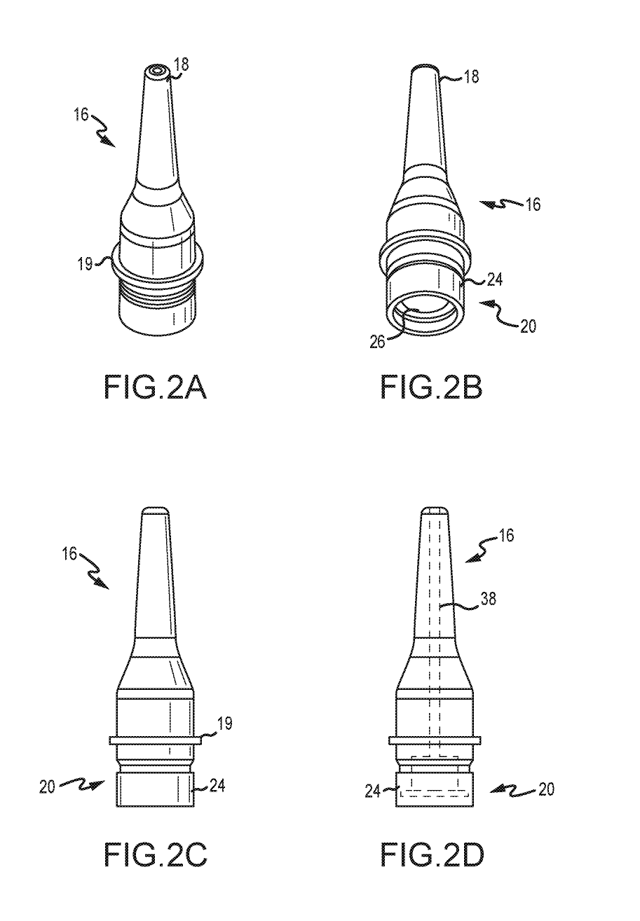

FIGS. 2A-2B provide a top perspective view and a bottom perspective view of a dispensing tip 16 of a dispensing device according to one embodiment of the present disclosure. As shown, the dispensing tip 16 comprises tapered end 18 extending from a body portion 20. The tapered end assists the user to dispense the fluid contents at a desired location. The body portion 20 comprises a collar 19 and a male portion 24 provided proximal to the collar 19. The male portion 24 is adapted for insertion into a body portion of the device 2. The male portion 24 of the device comprises an at least partially enclosed internal volume 26. In preferred embodiments, the internal volume 26 comprises a ball bearing that is biased toward a proximal end of the device and is adapted to seal an aperture in the proximal end of the dispensing tip 16. In certain embodiments, a coil spring (not shown in FIGS. 2A-2B) is provided internal to the dispensing tip 16 to bias the ball bearing to a closed position inhibiting the fluid contents of the device from escaping. The coil spring preferably comprises a first end in force-transmitting contact with an internal feature or flange of the tip 16, and a second end in force-transmitting contact with the ball bearing.

FIGS. 2C-2D are dimensioned elevation views of the tip 16 according to the embodiment of FIGS. 2A-2B. FIGS. 2C-2D and the various dimensions provided therewith are for illustrative purposes only, and no limitation with respect to dimensions or proportions of the tip are intended. Rather, FIGS. 2C-2D illustrate a tip 16 in accordance with one embodiment of the present disclosure, and various alternatives are also contemplated. FIG. 2D shows a fluid path 38 in phantom for illustrative purposes. The flow path 38 extends through a central portion of the tip 16 and preferably along a longitudinal axis thereof. As shown and described herein, the flow path 38 is selectively sealed by a valve or stopper.

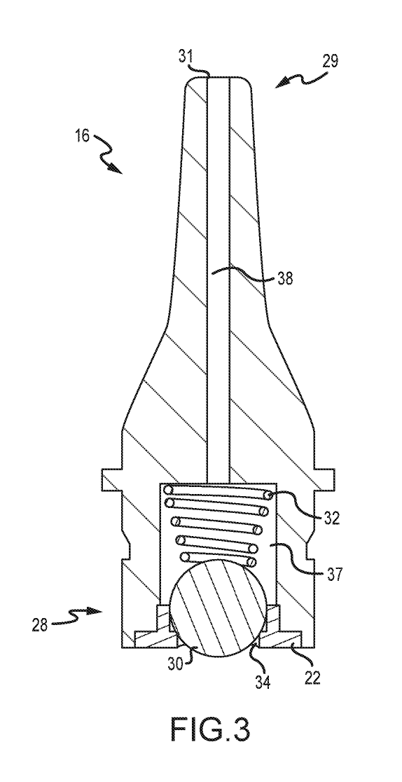

FIG. 3 is a cross-sectional elevation view of a dispensing tip 16 according to one embodiment of the present disclosure. As shown, the tip 16 comprises a first end 28 and a second end 29. The second end 29 comprises an outlet 31 for dispensing contents from a pen (not shown in FIG. 3). The first end 28 comprises an internal collar 22. The collar 22 accommodates a ball bearing 30 that is biased toward the first end by a coil spring 32. The embodiment of FIG. 3 provides a stopper or valve element in the form of a ball bearing 30. It will be recognized, however, that the stopper or valve element may alternatively comprise other stopper devices including, but not limited to, a round, cylindrical, or conical plunger element, a disc-shaped stopper, a frustoconical stopper, and similar devices.

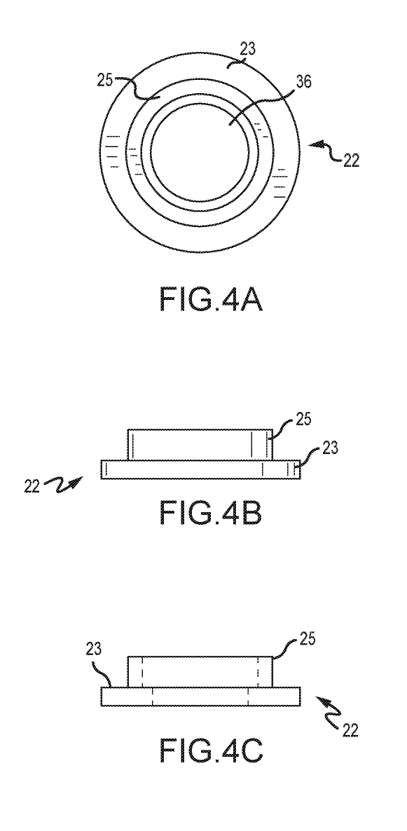

In the arrangement shown in FIG. 3, the ball bearing 30 is biased toward a closed or sealed position by the coil spring 32 such that device contents are substantially prevented from leaking out or being dispensed without a user input. Preferably a seal 34 is created between the ball bearing 30 and an inner circumference of an aperture 36 (see FIGS. 4D-4E) provided in the collar 22, wherein the ball bearing 30 is biased or forced against the seal 34. Upon activation of the device, as shown and described herein, a force is applied by a user to a volume of fluid or other contents provided within the device. The fluid is preferably incompressible or semi-incompressible, such as an oil or other viscous liquid. As a result, the force is transferred through the fluid to the ball bearing 30 and the spring 32. The force is sufficient to displace the ball bearing 30 and compress the spring 32 and allow a finite amount of device contents to flow past the ball bearing 30. The contents preferably flow around the ball bearing 30 and/or the spring 32 into a chamber 37 in which the spring 32 and at least a portion of the ball bearing 30 are disposed. The contents ultimately flow through a channel 38 provided in the tip 16, the channel 38 comprising an outlet 31 at the second end of the tip 16. One of skill in the art will recognize that the cross-sectional length and shape of the channel and/or the dispensing tip may vary without deviating from the scope of the present disclosure.

FIGS. 4A-4E provide various views of a collar 22 according to one embodiment of the present disclosure. As shown, the collar 22 comprises a central aperture 36 adapted to receive a ball bearing (FIG. 3, 30, for example) and create a seal to prevent device contents from unwanted egress from the device 2. The collar 22 comprises a flange 23 and an upstanding annular portion 25. The upstanding annular portion 25 is adapted to extend into the assembled device 2 and provide a seat for the ball bearing 30. At least one seal is provided between the ball bearing and the aperture provided in the flange 23. A seal may also be provided between the ball bearing 30 and an upper/inner annular surface of the upstanding annular portion 25 (See FIG. 3). FIGS. 4B-4C provide various dimensions of a collar 22 in accordance with one embodiment of the present disclosure. The dimensions of FIGS. 4B-4C are provided in millimeters.

As shown in FIG. 4D, the collar 22 comprises an upstanding annular portion 25 having a first internal diameter and a second annular portion 27 that comprises a second internal diameter. In various embodiments, the second internal diameter is smaller than the first internal diameter and a ball bearing or similar stopper member is operable to translate within the upstanding annular portion and creates a seal with the second internal diameter provided on the second annular portion 27. Although not shown in FIG. 4D, the collar member 22 may comprise additional sealing elements including, for example, one or more gaskets to enhance a seal between the collar 22 and a ball bearing or other stopper. For example, it is contemplated that a gasket is provided along the internal diameter of the second annular portion 27. The gasket is operable to contact a ball bearing or similar stopper and create a seal when the components are in contact.

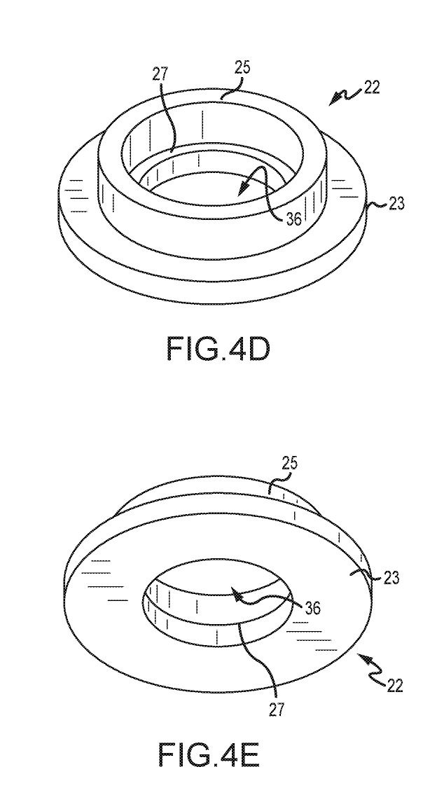

FIGS. 5A-5B provide various views of a biasing element, in this case a coil spring 32, in accordance with one embodiment of the present disclosure. In preferred embodiments, a biasing element 32 is provided with a sufficient spring constant to maintain a ball in a closed position when the device is not in an active dispensing operation. The spring constant, however, is low enough that a ball bearing or comparable valve or sealing element is forced to an open position upon activation of features of the device, including an application of force to device contents (e.g., in at least one embodiment, oil) which is transferred through the contents to the valve or sealing element. Coil springs for use with embodiments of the present invention are contemplated as comprising a spring force of between approximately 0.10 lb-feet and approximately 0.50 lb-feet. In at least one embodiment, a coil spring is provided that comprises a spring force of 0.312 lb-feet. Additionally, the coil spring 32 preferably has an inner diameter Dᵢ that is sized to receive a ball bearing 30 such that the ball bearing 30 does not pass through the coil spring 32 but is provided in force-transmitting communication with an end of the coil spring 32 as shown in FIG. 3.

Once the ball bearing 30 is forced open, a finite amount of device contents are forced around or past the bearing. After such passage, an internal pressure in a storage volume of the device will be reduced to a pressure that is less than a force exerted by the coil spring 32. As such, the coil spring 32 returns the ball bearing 30 to a closed position and prevents further dispensing or leaking of the device contents.

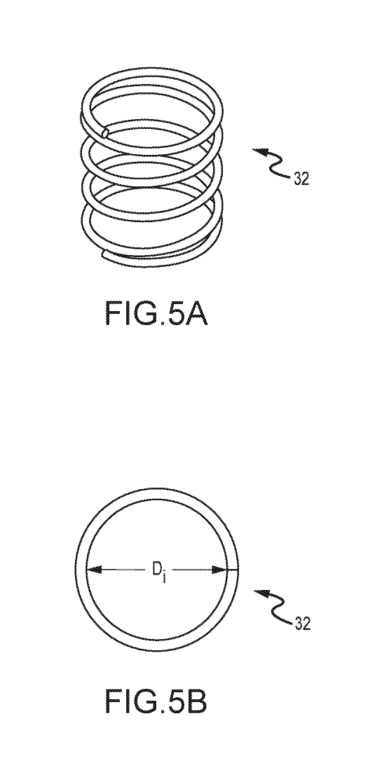

FIG. 6 is an exploded view of an oil dispensing device 2 according to one embodiment of the present disclosure. As shown, various components are provided in a disassembled state. When combined, the components provide for a fluid dispensing device that is adapted to dispense a discrete or finite amount of device contents whenever a user-interface 10 is activated by a user. The components, as shown and described herein, are generally housed within the elongate body portion 14 between a dispensing tip 16 and a butt cap 54. A user-interface 10 is provided that extends at least partially outward from the elongate body portion and the butt cap 54 when the device is provided in an assembled state. The user-interface 10 also extends axially and inwardly into the elongate body portion 14 and interacts with additional components. The user-interface 10 is preferably rotationally fixed with respect to the butt cap 54 by at least one notch or rib on the interface 10 that is received in a slot or other corresponding feature in the butt cap 54 and/or the elongate body portion 14. The user-interface is also translatable in a longitudinal direction and along a longitudinal axis of the assembled device 2 in order to actuate dispensing features of the device 2. The user-interface 10 extends at least partially into a sleeve member 40. The sleeve member 40 comprises external ribs 41 or protrusions that communicate with opposing ribs, protrusions, recessions, or other features provided on an internal surface of the elongate body portion 14 such that the sleeve is rotationally fixed with respect to the elongate body portion 14. A distal end 11 of the user-interface 10 preferably comprises protrusions or teeth that mate with protrusions or recesses on an internal surface of the sleeve 40, wherein the user-interface 10 and the sleeve 40 are rotationally fixed with respect to one another and with respect to the elongate body portion 14 and/or the butt cap 54.

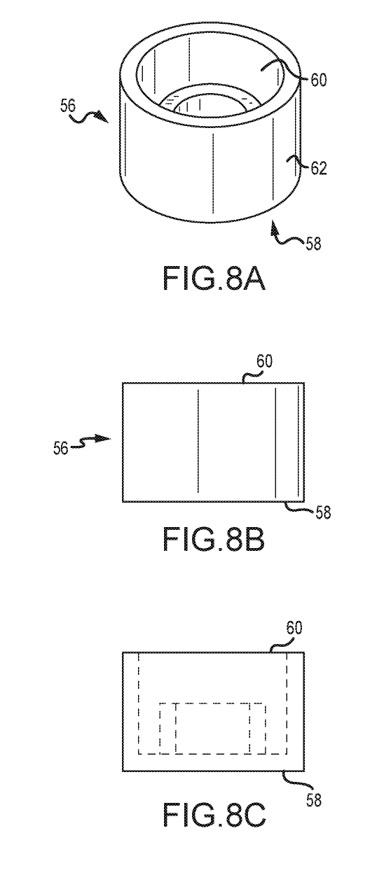

An actuator 42 is provided, wherein a proximal end of the actuator 42 is received by and extends into the distal end 11 of the user-interface 10. The actuator 42 is provided with a collar member 44, the collar member 44 adapted for indexing and moving the actuator 42 in a rotational manner. The collar member 44 moves axially along the length of the actuator 42, but in operation abuts the flared distal end 45, of the actuator 42. As shown in FIG. 9, the collar 44 is provided with a plurality of axially oriented ribs 72 generally equally spaced about the outer surface 70. The proximal end of the ribs 72 have an angled surface which interfaces with distally protruding teeth 13 formed on the distal end 11 of the user interface 10. Movement of the user interface 10 in the axial direction cases the teeth to engage the angled surfaces of the rib(s) 72 and thereby rotate the collar member a finite amount.

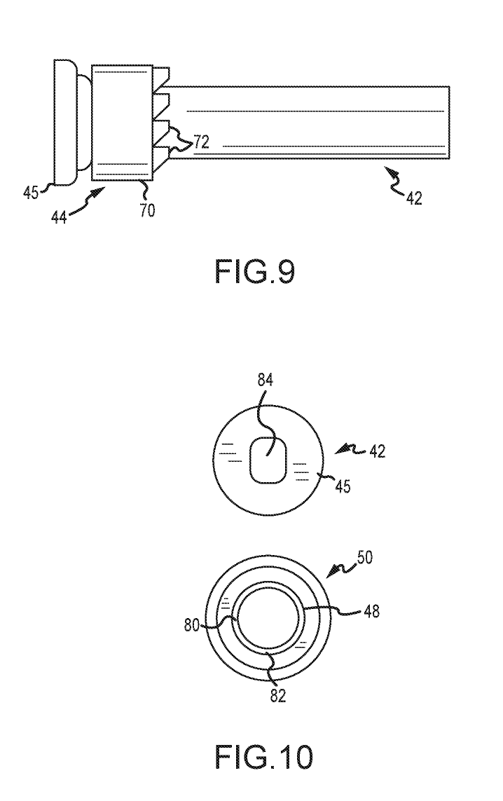

As shown in FIG. 6, a threaded rod 48 is positioned distally within the actuator 42 and is configured to interface with the actuator 42. In preferred embodiments, and as shown in FIG. 10, the threaded rod 48 comprises a non-circular cross-sectional shape with opposing flat or planar portions 80 and opposing rounded and threaded portions 82. A distal end of the actuator 42 comprises a hollow core or aperture 84 having a corresponding cross-sectional shape to receive the proximal end of the threaded rod 48 therein. As a result, when the collar member 44 causes the actuator 42 to rotate, the threaded rod 48 is also caused to rotate. The actuator 42 is thus rotationally fixed with respect to the threaded rod and operable to cause or affect a rotation of the threaded rod 48. Accordingly, in preferred embodiments, the threaded rod 48 rotates or indexes by a predetermined amount upon each depression or activation of the user-interface 10 by a user.

In addition, a nut 50 is provided on the threaded rod 48, and the nut 50 is preferably in force-transmitting communication with an interior portion of the elongate body portion 14 such that rotation and movement of the nut 50 is restrained, and rotation of the rod induces a linear or translational movement of the threaded rod 48. In this manner, each “click” or depression of the user-interface 10 corresponds to a discrete and predictable movement of the threaded rod 48 toward a distal end of the device and effects the dispensation of a predetermined amount of device contents through the dispensing tip 16. Furthermore, the nut 50 preferably comprises protrusions or extensions that are received within corresponding slots in an interior wall of the elongate body portion 14. In preferred embodiments, a distal end 52 of the threaded rod 48 is provided with a plunger 56. The plunger 56 preferably comprises a rubber member adapted to force an oil, fluid or liquid through the device, and to provide a seal along an interior surface portion of the barrel of the indicium 12 or other portion of the device 2 wherein contents are stored.

A biasing member 46 is provided to apply a biasing force upon the actuator 42 and bias the actuator 42 away from the nut 50 such that the user-interface 10 is returned to an initial position after each depression and the ribs 70 and teeth 72 of the collar 44 disengage from the distal end 11 of the user-interface 10. In this manner, the nut 50 provides a member to oppose the force of the biasing member 46 and bias the actuator 42 and related components in a proximal direction.

In various embodiments, dispensing devices 2 as shown and described herein comprise non-refillable devices. It is contemplated that such devices are pre-filled with an amount of oil or other contents prior to or during assembly. Once the entirety of the contents is dispensed or exhausted by a user, the device is not refillable and is intended to be discarded, recycled, etc. In alternative embodiments, devices 2 of the present disclosure comprise refillable devices wherein a user may replenish or replace device contents. Such embodiments contemplate that certain features of the device 2 are detachable with respect to one another and wherein an interior storage volume for oil or other contents may be refilled from an additional source.

In the embodiment shown in FIG. 6, the nut 50 comprises a substantially fixed object. The user-interface 10, sleeve member 40 and actuator 42 comprise displaceable, reciprocating components that move linearly. However, the user-interface 10, sleeve member 40 and actuator 42 move in a relatively limited distance as they are restrained by the nut 50. A depression of the user-interface 10 results in a reciprocating back-and-forth motion guided at least in part by the coil spring 46. However, each reciprocating movement of the user-interface 10 causes a rotation of the actuator 42 based on the communication between the distal end 11 of the user-interface and the collar member 44. Corresponding ramped or toothed portions of the distal end 11 and the collar member 44 induce a rotation of the actuator 42, which induces a corresponding rotation of the threaded rod 48. This rotation of the threaded rod 48 and a contact with the threaded and immovable nut 50 induces a linear displacement of the threaded rod 48 and a plunger provided on a distal end 52 of the threaded rod. This movement provides a force to an oil or other fluid substance provided within the device and forces open a valve member provided in the dispensing tip 16 to enable dispensation of device contents.

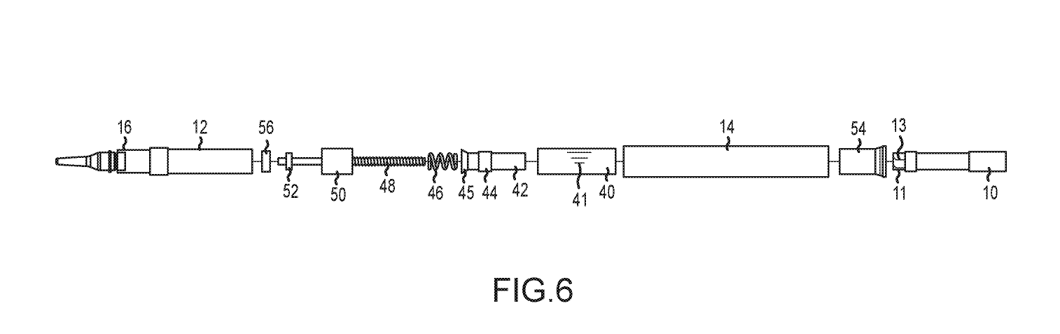

FIG. 7 is a cross-sectional view of a dispensing device according to one embodiment of the present disclosure provided in an assembled state. Various features as shown and described with respect to FIG. 6 are provided in FIG. 7. FIG. 7 also illustrates an interior volume 100 of the device, wherein the interior volume 100 is provided to house or store oil or other fluids. The plunger 56 is provided as an advancing plunger, which moves forward (right-to-left in FIG. 7) with each activation of the user interface 10. The plunger provides a force to the oil or fluid stored in the interior volume 100 of the device. A compression force that is applied to the fluid in the interior volume 100 is translated to a stopper element (not shown in FIG. 7) and ultimately forces device contents out through the dispensing tip 16.

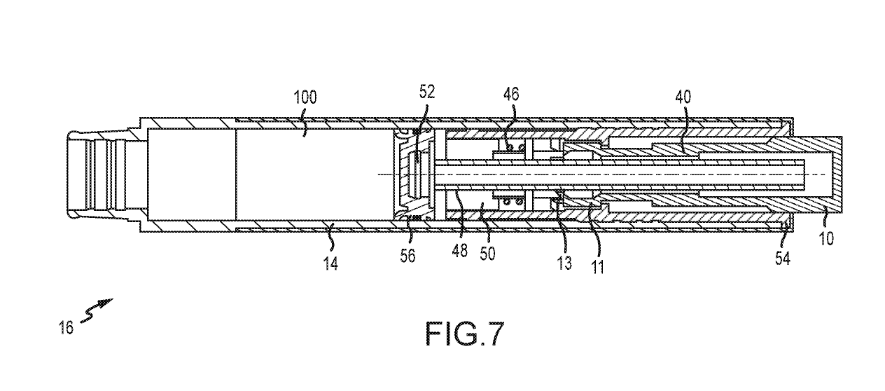

FIG. 8A is a top perspective view of a plunger 56 in accordance with one embodiment of the present disclosure. The plunger 56 comprises a distal end 58 that is operable to contact and apply a force to a fluid or oil. A proximal end 60 of the plunger 56 comprises one or more apertures or recesses to receive a distal end 52 of the threaded rod 48 (See FIG. 7). The plunger 56 preferably comprises a rubber or similar material, such that a seal is provided between the plunger 56 and an interior sidewall of the device 2. In certain embodiments, the plunger 56 comprises an elastomeric formulation including various rubbers. The plunger 56 comprises an exterior sidewall 62 that is preferably of sufficient length to create a seal between the plunger 56 and an interior sidewall of the chamber 12 housing the fluid content. FIGS. 8B-8C provide dimensions of a plunger 56 according to one embodiment. The present disclosure is not limited to the plunger 56 provided in FIGS. 8B-8C. Rather, FIGS. 8B-8C are provided for illustrative purposes and depict one contemplated embodiment. The dimensions provided in FIGS. 8B-8C are provide in millimeters. Although the plunger 56 shown in FIGS. 8A-8C is a generally cylindrical device, various alternative plungers are contemplated for use with embodiments of the present disclosure. For example, various ribbed or valved plungers and stoppers may be provided within an oil dispensing device 2.

While various embodiments of the system have been described in detail, it is apparent that modifications and alterations of those embodiments will occur to those skilled in the art. It is to be expressly understood that such modifications and alterations are within the scope and spirit of the present disclosure. Further, it is to be understood that the phraseology and terminology used herein is for the purposes of description and should not be regarded as limiting. The use of “including,” “comprising,” or “having” and variations thereof herein are meant to encompass the items listed thereafter and equivalents thereof, as well as, additional items.

What is claimed is:

1. A dispensing device for dispensing fluids, oils and viscous liquids, the device comprising:
an elongate body member comprising a first end and a second end;
the first end comprising a user interface, and the second end comprising a dispensing tip;
an interior volume for storing a first predetermined amount of fluid, the interior volume at least partially disposed between the user interface and the dispensing tip;
the user interface provided in communication with a plunger, the plunger comprising a surface for applying a compression force to the first predetermined amount of fluid;
the dispensing tip comprising a biasing member in force-transmitting communication with the dispensing tip and a ball bearing, the biasing member biasing the ball bearing toward a closed position; and
wherein activation of the user-interface provides a compression force to the first predetermined amount of fluid and the forces the valve member to an open position to allow for a second predetermined amount of fluid to be dispensed from the dispensing tip.

2. The dispensing device of claim 1, wherein the user interface comprises a push button, and wherein the push button is in communication with at least one ramped surface to convert a linear motion to a rotational motion.

3. The dispensing device of claim 1, wherein a plunger is provided on an end of a threaded rod and wherein the plunger and the threaded rod are linearly displaced by a predetermined amount when the user interface is activated.

4. The dispensing device of claim 1, wherein the dispensing tip comprises a first end and a second end, the first end comprising an outlet for device contents and the second end comprising a collar with an aperture.

5. The dispensing device of claim 4, wherein the collar comprises an annular surface and wherein the ball bearing is biased against the annular surface by the biasing member to create a seal.

6. The dispensing device of claim 1, wherein the threaded rod extends through a fastener, the fastener being secured to an interior portion of the elongate body member such that a rotational movement of the threaded rod with respect to the fastener induces a linear movement of the fastener.

7. The dispensing device of claim 1, wherein the elongate body member comprises a visual indicium for viewing contents within the device.

8. The dispensing device of claim 7, wherein the visual indicium comprises at least one of a transparent and a translucent portion of the elongate body member.

9. A dispensing device comprising:
an elongate body member;
a dispensing tip provided on one end of the elongate body member;
a user interface provided on a second end of the elongate body member;
an interior volume provided within the elongate body member, the interior volume at least partially disposed between a user interface and the dispensing tip;
the user interface provided in communication with a plunger, the plunger comprising a surface for applying a compression force to at least one of an oil and a fluid stored in the interior volume;
the dispensing tip comprising an outlet for dispensing contents from the device, and the tip comprising a biasing member in force-transmitting communication with a stopper;
an annular collar member comprising an aperture;
wherein the biasing member is operable to bias the stopper against a circumference of the aperture of the annular collar member to create a seal between the stopper and the annular collar member;
a fluid flow path extending from the interior volume to the outlet of the dispensing tip, and wherein the stopper is provided in the fluid flow path;
wherein activation of the user-interface provides a compression force to the at least one of an oil and a fluid and forces the stopper to an open position.

10. The dispensing device of claim 9, wherein the stopper comprises a ball bearing.

11. The dispensing device of claim 9, wherein the stopper comprises a rubber stopper.

12. The dispensing device of claim 9, wherein the stopper is biased in and moveable along a longitudinal axis of the dispensing device.

13. The dispensing device of claim 9, further comprising a threaded rod and wherein the plunger is provided on and displaceable relative to the threaded rod.

14. The dispensing device of claim 13, wherein an activation of the user interface causes a rotation of the threaded rod and a linear displacement of the plunger.

15. A dispensing device for dispensing fluids, oils and liquids, the device comprising:
an elongate body member having a reservoir for storing fluid;
a dispensing tip provided on one end of the elongate body member;
a user interface provided on a second end of the elongate body member and in communication with a plunger, the plunger operable to expel stored fluid from the reservoir;
the dispensing tip comprising a flow path including an outlet for dispensing stored fluid from the dispensing device, and the dispensing tip comprising a ball bearing operable to create a seal in the flow path;
an annular collar comprising an aperture;
wherein the ball bearing is biased against an internal circumference of the aperture of the annular collar to create a seal between the ball bearing and the annular collar and to restrict fluid flow through the flow path;
wherein activation of the user interface is operable to provide a force to a stored fluid and force the ball bearing to an open position to allow the stored fluid to be dispensed from the dispensing tip.

16. The dispensing device of claim 16, further comprising a coil spring and wherein the coil spring biases the ball bearing against the annular collar.

17. The dispensing device of claim 16, wherein the ball bearing is provided within the flow path and wherein stored fluid flows around the ball bearing prior to dispensation.

18. The dispensing device of claim 16, wherein a stored fluid is provided between the plunger the dispensing tip.

19. The dispensing device of claim 16, further comprising a threaded rod and wherein the plunger is provided on and displaceable relative to the threaded rod.

20. The dispensing device of claim 19, wherein an activation of the user interface causes a rotation of the threaded rod and a linear displacement of the plunger.
